(19) United States
(12) Patent Application Publication
(10) Pub. No.: US 2026/0030712 A1
(43) Pub. Date: Jan. 29, 2026

(54) SUB-IMAGE STREAMING AND PROCESSING

(71) Applicant: MELLANOX TECHNOLOGIES, LTD., Yokneam (IL)

(72) Inventors: Dotan David Levi, Kiryat Motzkin (IL); Yechiel Wiesel, Tel Aviv (IL); Wojciech Wawrzyniec Wasko, Mlynek (PL); Natan Manevich, Migdal HaEmek (IL); Elad Mentovich, Tel Aviv (IL)

(21) Appl. No.: 18/787,408

(22) Filed: Jul. 29, 2024

(51) Int. Cl. G06T 1/20; H04N 19/127; H04N 19/176; H04N 19/42

(52) U.S. Cl. CPC G06T 1/20; H04N 19/127; H04N 19/176; H04N 19/42

(57) ABSTRACT

Systems and methods herein are for distributed image processing by at least a data processing unit (DPU) and using at least a graphics processing unit (GPU) in possible association with a field programmable gate array (FPGA). For example, the FPGA may be used to perform physical layer processing for images captured by the image sensor or from a simulation and can provide a media stream for the DPU and the DPU can provide payload of only image sections from the images in a media stream for the GPU to perform content layer processing for only the image sections of the images.

### TECHNICAL FIELD

At least one embodiment pertains to image processing for images of a media stream.

### BACKGROUND

Video compression can be used to provide reduced media streams while preserving detail, to an extent, of content of an underlying video. Such media streams may be part of different streaming technologies that extend beyond traditional broadcast markets. In one example, Ethernet and other networking technologies may contribute to developments in the media streaming technologies. However, diverse applications may have diverse requirements in their media streams. For example, education-based online learning platforms may use media streaming for lectures and interactive sessions, to make education accessible worldwide. Healthcare applications, such as, telemedicine applications allow media streaming for consultations and to enable remote diagnosis and treatment. Further, gaming applications may rely on streaming platforms to revolutionize how games are played and viewed. In some or all of these applications, Ethernet may play a role in providing high-speed and stable connectivity that may be crucial to extend media streaming. For example, there may be high-bandwidth and low latency requirements that may be vital for these and other applications. In addition, with the developments in virtual reality (VR) and augmented reality (AR), immersive media streams for entertainment and training occupy substantial bandwidth, along with media streams for smart cities, in the form of traffic management and public safety. In one example, efficient video compression and transmission, along with advancements in data storage and processing technologies have made it feasible to stream high-quality content reliably over the internet. However, processing is still performed for a large volume of images which may cause latency in high speed, high quality processing situations.

### BRIEF DESCRIPTION OF DRAWINGS

FIG. 1 is an illustration of a system for separating physical layer processing for images from content layer processing for only image sections of the images, in at least one embodiment;

FIG. 2 is an illustration of aspects of a system for providing sequence numbers for payload representing only image sections of images to allow processing of only the image sections, in at least one embodiment;

FIG. 3 is an illustration of further aspects of a system for arranging payload representing only image sections in a shared buffer to allow processing of only the image sections, in at least one embodiment;

FIG. 4 illustrates computer and processor aspects of a system for separating image sections from images for processing of only image sections, in at least one embodiment;

FIG. 5 illustrates a process flow for a system for separating physical layer processing for images from content layer processing for only image sections of the images, in at least one embodiment;

FIG. 6 illustrates yet another process flow for a system for providing sequence numbers for payload representing only image sections of images; and

FIG. 7 illustrates a further process flow for a system for arranging payload representing only image sections in a shared buffer, in at least one embodiment.

### DETAILED DESCRIPTION

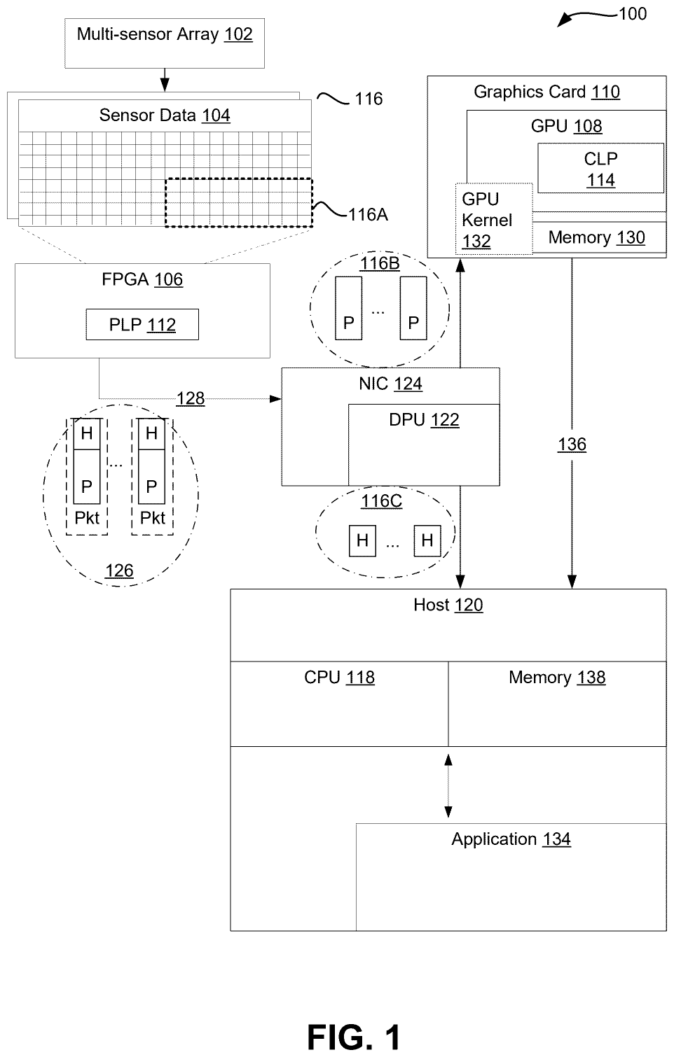

FIG. 1 is an illustration of a system 100 for separating physical layer processing for images from content layer processing for only image sections of the images, in at least one embodiment. The system 100 provides multi-instance integration for image processing of images for a media stream by embracing complexity of data acquisition and processing associated with multiple sensor instances, such as, a multi-sensor array 102. As used herein, the media stream, the images, and the image sections herein may be part of a video and may be frames or portions thereof, for the video. Further, as used herein, the images may be formed from an image sensor having the multi-sensor array 102, may be formed from stimulation sensors, or may be formed from simulated data.

In one example, the stimulation sensors may be a combination of one or more of magnetic and radio sensors that are capable of providing information to generate an image. For instance, the system 100 is capable of being an Magnetic Resonance Imaging (MRI) machine or a Computer Tomography (CT) machine. The system 100 also provides advanced image processing by specialized handling of both static and partial images, along with dummy sensor compatibility to expand versatility by proficient interfacing with dummy sensors to serve as agile transmitters. In one example, such use of dummy sensors can support a broad range of experimental, simulation, and calibration setups to enable the advanced image processing herein.

Further, the system 100 includes direct transfer of image or sensor data 104, from a multi-sensor array 102 associated with a field programmable gate array (FPGA) 106, to a graphics processing unit (GPU) 108, absent intervention for processing requirements by a central processing unit (CPU) 118 of a host 120, also referred to herein as a host machine. The system 100 herein can also support separation of physical layer processing (PLP) 112 for images 116, which may be performed in the FPGA 106, from content layer processing (CLP) 114. The PLP 112 may include processing associated with symbols or floating point representation of the images, whereas the CLP 114 may include processing associated with pixels or metadata representation of the images.

Further, the CLP 114 may be performed in the GPU 108 for only image sections or sub-images 116A of the images 116. Further, although illustrated on one image, the image sections 116A may be different in different ones of the images 116 and may also include different parts of each of images 116. In one example, the image sections 116A may be a Region of Interest (Rol), may be an object, or may be an area of motion, relative to other areas in the images. Further, while a media stream 126 of packets (“pkt”) may include payload (“P”) and an associated header (“H”), which may be provided for the entire images 116, the image sections 116A may be presented as a select payload 116B separated from the packets by a data processing unit (DPU) 122 and provided by the DPU 122 to the GPU 108 for the processing.

Such an approach bypasses bottlenecks that may otherwise require a CPU 118 to intervene in many aspects of the image processing. For example, the CPU 118 may otherwise be required to receive a media stream 126 and may be required to copy entire images to the GPU memory 130. The approaches herein, which may at least include the DPU 122 presenting a payload 116B, corresponding to the image sections 116A, to the GPU 108 for the processing, accelerates image processing and analysis in the system 100. In at least one embodiment, the system 100 herein support header-data splitting (HDS) to smartly delegate the payload 116B to a GPU 108, with the headers 116C delegated to the CPU 118 and to be stored in a memory 138 of a host 120, as part of the separation of the PLP 112 from the CLP 114, herein. This additionally accelerates and enhances image processing but also reduces system overhead.

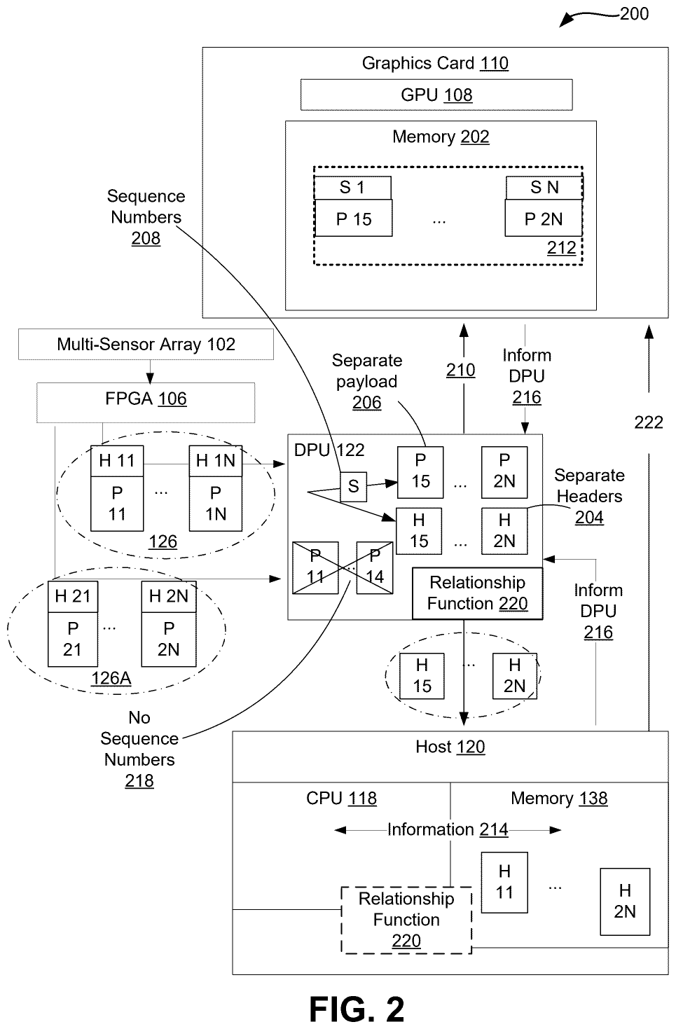

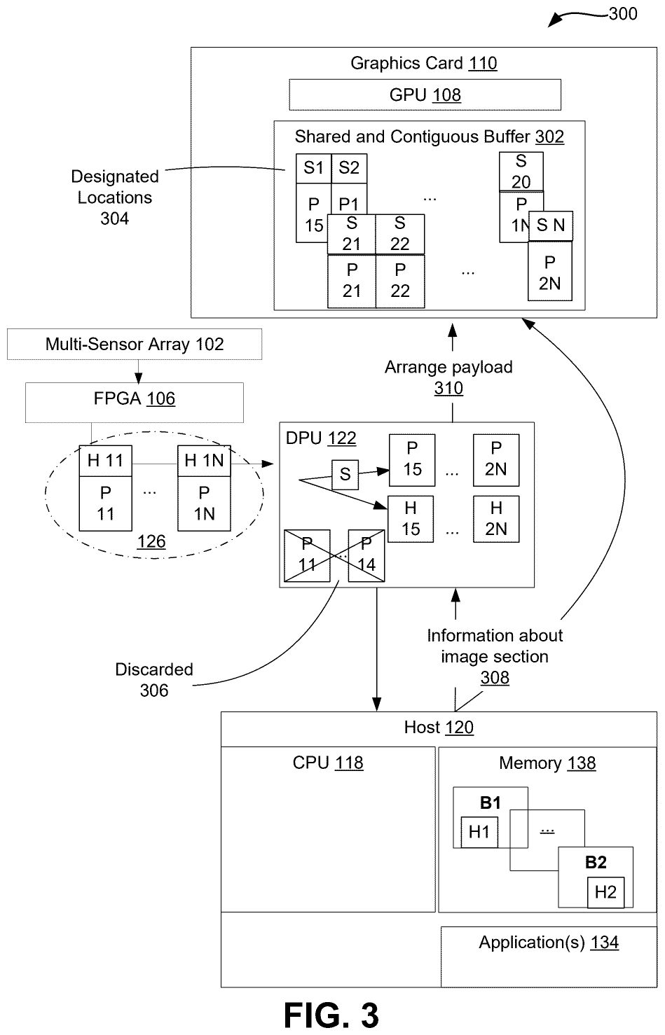

In at least one embodiment, the system 100 herein also incorporates direct packet placement (DPP), which is directed to the use of unique identifiers, such as, sequence numbers, as described further with respect to at least FIG. 2, for payload from a DPU 122 of a network interface card (NIC) 124. This included approach ensures that an arrival sequence of a media stream 126 is immaterial and not relied upon in the GPU and, instead, the sequence numbers may be utilized to offer flexibility in data handling and streamlining of a workflow 128 associated with the image processing to be performed by a GPU 108. In at least one embodiment, the system 100 also supports duplication with zero cost by leveraging DPP to provide redundant stream handling at no additional resource expense. The duplication process proficiently writes directly to a buffer or other memory 130 associated with the GPU 108 and which may be designated for each specific payload 116B, which is described further with respect to at least FIG. 3. This ensures data integrity and reliability to the system 100.

Further, the system 100 can operate in a multi-threaded environment and can efficiently manage still or partial images. For example, the system 100 can receive and process sensor data 104 from simulated dummy sensors instead of, or together with, the multi-sensor array 102. In one example, in an experimental, simulation, or calibration setup, it is possible to simulate data acquisition of sensor data 104 instead of from a multi-sensor array 102. Further, it is possible to provide simulated version of the sensor data 104 with PLP 112 applied to suit an intended experiment, simulation, or calibration, with the remaining features for using image sections applied using at least the DPU 122 and GPU 108 configurations herein. In the experimental, simulation, or calibration setup, there may be no need for an image sensor having the multi-sensor array 102. Instead, an image (or sensor data 104) may be simulated from the FPGA 106 or a different DPU. For example, in the experimental, simulation, or calibration setup, a DPU for generation of the simulated sensor data 104 may communicate with the illustrated DPU 122, which can simulate a compute node for performing all aspects of the live application, along with the GPU 108 and the host 120.

In at least one embodiment, the system 100 may include an image sensor as part of the multi-sensor array 102. The image sensor may be associated with the FPGA 106. In one example, the image sensor and the FPGA 106 are communicatively coupled together within a camera module. Separately, the FPGA 106 may be coupled to a DPU 122 of a NIC 124. In one example, the FPGA 106 may be coupled to the DPU 122 via an Ethernet link. However, it is possible to provide a peripheral component interconnect express (PCIe) standard interconnect or bus between these components. The DPU 122 may be, in turn, coupled to the GPU 108 via a separate PCIe bus. Although illustrated as being part of different cards, the DPU 122 and the GPU 108 may be part of a singular card and may communicate via the PCIe bus of the singular card.

In at least one embodiment, the singular card having a DPU 122 and a GPU 108 may be configured to be self-hosted. For example, the singular card offers direct access between the DPU 122 and the GPU 108, which enables the DPU 122 to send a payload of the image sections 116A directly to the GPU 108 without the host's intervention. The GPU 108 can process the image sections 116A based in part on application requirements of at least one application. For example, the application may be associated with a domain-specific algorithm that may be used to perform specific ones of an CLP 114 in a GPU 108. In one example, the GPU 108 is enabled to perform processes on the image sections 116A that may be based in part on different protocols and encapsulation methods. The different protocols may include Hypertext Transfer Protocol (HTTP) Live Streaming (HLS), which can be used for delivering live and on-demand content on the internet. Further protocols may include the Real-Time Messaging Protocol (RTMP), which may be used for high-performance transmission of audio, video, and data between Adobe® Flash® Platform technologies, and MPEG-DASH®, which offers adaptive streaming by adjusting a quality of video streams in real-time based on network conditions.

The encapsulation methods impact data integrity and transmission efficiency and may include MPEG® Transport Stream (MTS), which can preserve data integrity in a media stream 126 but that may also preserve data integrity for error-prone transmission mediums. Further, RTP or Real-Time Protocol may be used for delivering audio and video over networks, and WebRTC® may be used to enables real-time communication directly in web browsers. Still further the different streaming aspects to be enabled in the GPU 108 and may serve various use cases, including in applications requiring wide compatibility and adaptive streaming capabilities for which HLS may be used. RTMP may be used in low-latency streaming that may be crucial for live broadcasts. MPEG-DASH may be used when applications require flexibility and efficiency in a heterogeneous network environment.

In one example, when the system 100 is part of an MRI machine, the MRI machine may be provided in the form of a basic-magnet MRI. The basic-magnet MRI may be only associated with magnets and its radio frequency (RF) electronics to provide capturing of sensor data represented by symbols or floating point. The symbols or floating points may be analog representation of images that are to be subsequently rendered by a GPU. The system 100 for distributed image processing allows an FPGA 106 to perform the PLP on the symbols or floating point representation to be used in medical diagnostics and allows a GPU 108 and a DPU 122 to be used to perform CLP on a media stream having only image sections from the images. As such, the GPU and DPU combination may be located remotely from the basic-magnet MRI machine and need not be co-located to enable medical diagnostics.

Further, the FPGA is to perform PLP 112 for images 116 using the sensor data 104 and is to provide a media stream 126, representing a workflow 128, from the image sensor of the multi-sensor array 102. An outcome from the PLP 112 in that the FPGA 106 may provide payload (“P”) having headers (“H”), which are altogether associated with an arrival sequence of the media stream 126, for a NIC 124 having the DPU 122. The payload and headers of the media stream 126 may represent the sensor data 104 of images 116 processed by the PLP 112. The DPU 122 may be adapted to perform arrangement of the image sections 116A from the images 116 by arrangement of the payload 116B format in the media stream 126. For example, the DPU 122 can access a memory 130 that is associated with the GPU 108 and can place only image sections 116A, in the payload 116B format, to the memory 130. Further, the arrangement performed by the DPU 122 may be based in part on information about image sections, such as, from an application 134 performed by the CPU 118. For example, the CPU 118 uses input from an application 134 to provide information 216 of one or more image sections to be provided to a GPU 108. However, the CPU 118 may also use the headers to provide such information.

In at least one embodiment, the GPU 108 can perform content layer processing for only the image sections 116A from the images 116 using the payload 116B arranged in an associated buffer memory 130, absent further CPU intervention. Further, in one example, while the PLP 112 may include one or more of an analog-to-digital conversion (ADC), a noise estimation, or a timestamping. The CLP 114, in one example, includes one or more of pattern recognition, object recognition, feature extraction, feature characterization, or image segmentation. Therefore, it is apparent that the physical layer processing herein may include one or more operations which are oblivious to content of the images or which are performed only considering raw pixel data associated with the images. In contrast, it is apparent that the content layer processing herein includes one or more operations which are to consider a content of the images or which are performed on raw pixel data with due consideration to content within the images.

Further, the PLP 112 may be devoid of business logic or that may be independent or agnostic of an application requirement from a host 120. The application requirement may be from an application that may want to utilize one or more of the images sections 116A, but the PLP 112 may not need to be aware of this requirement. In addition, a GPU kernel 132 may be is associated with the GPU 108 and the DPU 122. The GPU kernel 132 can interface with the DPU 122 to indicate to the DPU 122 only the image sections 116A, in the payload 116B format, that it is to receive and which are to be subject to the CLP 114. In one example, the GPU kernel may function using command scripts from a memory. Therefore, the CPU or the GPU may have application knowledge of one or more image sections to be obtained from the DPU to the GPU for image processing according to the application requirements.

A GPU kernel 132 can function based in part on its command scripts being executed on the GPU 108 to support a range of host kernels associated with the CPU 118 of a host 120. The GPU kernel 132 can be executed many times and may be executed in parallel by different threads on the GPU 108. In one example, each thread may be assigned a unique identifier or an index to be used to compute memory addresses and for control decisions. Further, kernel calls associated with a GPU kernel 132 may be executed by different circuits forming multiprocessors cores within the GPU 108. These circuits allow performance of the different threads, in one instance. These different threads may be subject to scheduling and may be used to perform image processing for streaming applications.

In FIG. 1, the system 100 is such that the GPU 108 may be able to communicate with the DPU 122 using the PCIe bus to receive only the image sections 116A. However, the GPU 108 can perform the CLP 114 absent intervention by a CPU 118. For example, there need not be further directive from the CPU 118 to the DPU 122 with the image sections 116A. In one example, a CPU 118 of the host 120 may only be able to instruct or inform the DPU 122 as to the image sections 116A relevant to an application's requirement. This may be based in part on predetermined information about the image sections provided from an application 134. However, this may also include the headers 116C provided from the NIC 124. The CPU 118 may not provide any further intervention for the GPU 108. The predetermined information may be also provided 222 to a GPU 108 to allow the GPU 108 to instruct or inform the DPU 122 as to the image sections 116A relevant to an application's requirement.

In addition, the DPU 122 can also perform its arrangement of the image sections 116A, using the payload 116B, in the memory 130 associated with the GPU 108. This may be based in part on a buffer that forms the memory 130 associated with the GPU 108 and that is dedicated for the image sections 116A (using the payload 116B). Further, the DPU 122 can also perform the arrangement based in part on providing at least one identifier associated with the image sections 116A (or assigned to each of the payload in the payload 116B) to identify each payload 116B as belonging to the same image sections 116A, for instance. The GPU 108 can then access the buffer to perform the CLP 114 using the image sections 116A from the buffer and using the at least one identifier.

In at least one embodiment, the media stream 126 may include the header and a payload. In one example, one or more PCIe buses may include transactions for the media stream 126 between the FPGA and the DPU and for payload between the DPU and the GPU. For example, the transactions may include payload representing image sections transferred from the DPU to the GPU's buffer. The transactions may include headers transferred by the DPU to a buffer of a host and its associated CPU. In one example, the CPU or host monitors arrival of the entire images (which may include all payload and headers of a full video frame). The CPU or host can trigger the GPU to perform processing for the image sections, in one example.

With respect to experimental, simulation, and calibration setups, the system 100 may be used for various tests by causing the multi-sensor array 102 to simulate sensor data 104. As such, the sensor data 104 may not represent an object captured by the multi-sensor array 102, but may be simulated data for testing aspects of image processing using the system 100. For example, one test may be for constant bandwidth in a multi-sensor configuration within the system 100. This test may include simulating multiple sensors of a multi-sensor array 102. Each of the sensors simulated may maintain a constant bandwidth of 5 Gbps. This test may measure power consumption and CPU usage while ensuring that no packet loss occurs or that no sender delay for up to 30 sensors occurs. The system 100 may be used for performing a full wire speed (FWS) multi-sensor test, in another example. In this test, each sensor of the multi-sensor array 102 may be adapted for transmitting at its maximum capacity to achieve full wire speed. Further, noting that a single sensor cannot reach FWS and highlighting this point may be another test enabled by the system 100 herein.

Yet another test supported by the system 100 may be a single sensor increasing frames per second (FPS) test. In this test, a single sensor of the multi-sensor array 102 may cause increase in an associated FPS. In turn, the increase in FPS may escalate bandwidth usage in increments. Therefore, to study the impact on system resources and data transmission, such a simulation may be performed using the multi-sensor array 102 and the approaches herein for separating physical layer processing for images from content layer processing that may be performed for only image sections of the images. Another test may be a single sensor non-limited stability test, which may be a long-term stability test using the system 100. In this test, a single sensor of the multi-sensor array 102 may be operated at non-limited speed with the remainder of the separation, the physical layer processing, and the content layer processing being performed. The system 100 may be monitored for a wire bandwidth, while the GPU and the DPU may be monitored for power consumption, and CPU may be monitored for core usage over time. One or more of all such tests may establish different deployment options for the system 100 herein to perform one or more aspects of the separation, the physical layer processing, and the content layer processing in different environments having different configurations of the aspects in FIGS. 1-4.

In at least one embodiment, at least one circuit of the GPU 108 can perform encoder functions as part of a video encoder. For example, an output of the GPU 108 may be a compressed or encoded media stream 136 for further use in an application 134 by the host 120 or a different (and remote) host. In at least one embodiment, at least the CPU aspects of the system 100 may be performed in a datacenter. The GPU 108 may use default video compression parameters to perform the video compression or encoding. For example, the GPU 108 may perform such video compression or encoding one only the image sections 116A to provide a compressed or encoded media stream that may be based in part on one of an H.264 standard, an MPEG2 standard, an AVC standard, an HEVC standard, a VP9 standard, an AV1 standard, or a VVC standard.

In one example, the GPU 108 may be associated with a mode selection module therein to be used to perform inter or intra mode coding. Such a mode selection may be performed using a mode selection module therein. The mode selection may enable selection of parameters that may be associated with available ones of the encoding parameters. The result of such mode selection is to provide specific encoding for the image sections 116A. The mode selection can also allow determination of how many bits the encoder is willing to sacrifice in order to conceal and/or eliminate a distortion that may be relevant to certain parts of the media selection.

As part of the encoding parameters, a Fourier or other related transform may be performed on blocks within every frame to convert data therein to a frequency domain and to allow quantization or discarding of information based on select frequencies. In doing so, transform coefficients at lower frequencies may be less aggressively quantized than those of higher frequency. Separately, motion estimation may be used to capture and encode movements across video frames. While all such options attempt to improve video compression, they may all serve a similar goal to allow an encoder to compress video into smaller bitstreams by eliminating noise, artifacts, allowing at least more intensive motion estimation and exploiting temporal and spatial redundancy. For example, transform and quantization may be provided by a transformation and quantization (T and Q) module of the encoder, as further parameters to influence one or more of the compression or the encoding.

In view of all such benefits, encoders may differ based in part on selections of proper tool(s) to enable aspects thereof to provide economy of bits. For example, the selections of proper tools is in reference to selection of encoding parameters to enable selection of areas (such as provided by macroblocks (MBs)) within frames of each image section 116A that may be subject to the compression or encoding described herein. This and other such approaches that may be defined within the encoder as different modes that may require more or less bits to ensure a desired quality. A Rate Distortion Optimization (RDO) module of the encoder may be associated with a mode selection module therein to address requirements by the use of RDO metrics, such as Sum of Squared Errors (SSE) or Sum of Transformed Differences (SATD) to determine a cost associated with each selection made and to enable a selection based on the cost.

Further RDO metrics allow further mode selection that benefit from evaluation using further quality measures, including VMAF, SSIM, MS-SSIM, or PSNR. Distortion may be determined as a difference from the original image. In at least one embodiment, the GPU 108 supports improved selection of at least the quality measures that may be used to perform the video compression for the image sections 116A herein. In one example, to provide the video compression or encoding herein, the encoder can receive transform coefficients or parameters, such as QPs. The RDO module can operate to optimize, for each point or block of an image section, an efficient representation that may include segmentation, prediction modes, motion vectors (MVs), or the QPs.

In at least one embodiment, use of the RDO output is to make a selection of a mode, as provided by the RDO module. Further, an RDO may be limited to a single point for each block in each image section 116A and may be represented by a linear equation of R+λ*D, where λ (lambda) is a multiplier and where an (R, D) pair may be used with the multiplier to minimize a combined R+D value. R may be associated with a bit rate and D may be associated with distortion as it pertains to quality of the media. The RDO allows ranking, for instance, of candidate solutions using the linear equation to select one of the candidate solutions. Therefore, the lambda value may be associated with a range from 1 to a minimized cost for the set of (R, D). R may be measured in bits and D may be a quality unit, such that the equation provides a measure of units of distortion for every bit of a bit rate used in a video compression process.

To achieve a predetermined bit rate of R, a certain value of lambda may be used. Further, selection of encoding parameters that may include R, D, and lambda values allow the RDO to use different quality measures with the image sections 116A. In at least one embodiment, an encoder of the GPU 108 may be subject to H.264 encoding. The encoder may include modules in hardware or software, such as a prediction module, the T and Q module, and an entropy coding module. There may be further modules, such as an inverse module, a filter module, a motion process module (to support motion estimation and related aspects), and a prior or reference frames module. The video compression or encoding herein may not have effect on a decoding process for a bitstream provided from the encoder. For example, the decoding process may be according to the H.264 decoding or other decoding relevant to the encoding format used to provide the output bitstream from the encoder and, particularly, as to the entropy coding module.

A bitstream of frames, representing only the images sections 116A of images 116 may be compressed or encoded in the GPU 108 and may include different MBs or macroblocks. In at least one embodiment, different sizes of MBs may be supported in the encoder, including but not limited to 8×8, 8×16, 16×8, 4×4, and 16×16. The MBs likely correspond to displayed pixel data obtained at the location of the blocks. The prediction module can generate a prediction MB that can be used to generate residual data reflective of data subject to quantization, as part of the video compression. There may be multiple prediction options associated with a prediction module, including intra prediction that is associated with previously encoded data that is from a current sequence, such as from each of the image sections 116A. Another option associated with a prediction module includes inter prediction that uses encoded data from other previously encoded frames having only the image sections 116A, as reference frames, such as from the prior or reference frames module. These reference frames can appear before or after the current frame, in the display order and may be associated with motion compensation, such as motion process module that uses previously coded frames, such as provided from the prior or reference frames module.

Yet another option associated with a prediction module includes the use of different prediction block sizes that is available to both, the intra prediction and inter prediction options. The use of different prediction block sizes of the MBs can change an accuracy associated with the predictions. A further option associated with a prediction module includes the use of multiple frames during prediction, which is available in the inter prediction option to provide better accuracy in the predictions. A still further option is to skip MB data or residual data so that the encoder itself performs an inference of the MB data based in part on the prediction MB. One or more of such options represent encoding parameters that may be applied to compress an image section 116A.

In at least one embodiment, intra prediction may be based at least in part on spatial data within at least each of the image sections 116A. MBs generated as part of the intra prediction may be distinct from the MBs of the frame of the image sections 116A. Residual data may be residual MBs generated by a subtraction of the prediction MB, from a current MB. The residual MB can be subject to transformation, quantization, and entropy coding in the provided modules of the GPU 108 depending on a mode selected by a mode selection module and that may be associated with the RDO module to perform the RDO, for instance. Further, in the encoder of the GPU 108, quantized data may be re-scaled and inverse transformed in the inverse module. An output of the inverse module may be filtered and combined with the prediction MB in the prediction module. Motion estimation from the motion process module may be included. The result may be a reconstructed MB or decoded frames that is provided to the prior or reference frames module for further predictions. In at least one embodiment, the use of one or more of inter prediction or intra prediction represent additional encoding parameters that may be applied to compress an image section 116A for further communication or processing in a host 120 or a remote host.

FIG. 2 is an illustration of aspects of a system 200 for providing sequence numbers for payload representing only image sections of images to allow processing of only the image sections, in at least one embodiment. The aspects of the system 200 in FIG. 2 may be all or in part the aspects already described with respect to the system 100 in FIG. 1. For example, the system 200 may include an image sensor which may be or may include a multi-sensor array 102, and which may be associated with a FPGA 106. The image sensor may be also associated with a GPU 108 and a DPU 122. The FPGA 106 can provide images 116 that are captured by the image sensor and that are in at least one media stream 126 to the DPU 122. The DPU 122 can separate headers 204 from payload associated with the images to provide separate payload 206 P 11 to P 2N. The DPU 122 can provide sequence numbers 208 for the separate payload 206, but only to those associated with image sections 116A of the images 116. Therefore, there may be payload, such as, payload P 11 to P 14 that may have no sequence numbers 218 as they may represent other than the image sections 116A of the images 116.

In at least one embodiment, the separate headers 204 are Real-Time Transport Protocol (RTP) headers. The media stream 126 may be built in the form of User Datagram Protocol (UDP) ports having a payload and the RTP headers. The separation of the payload and the arrangement of the payload directly to the GPU allows for seamless reconstruction of multiple media streams 126 of payload that may be concurrently received from the FPGA. The seamless reconstruction allows for the payload of different media streams to provided as a single stream at least between the DPU and the GPU. Further, this approach also support redundancy and reordering of packet arrival, as needed.

The DPU 122 can provide 210 the separate payload 206 with the sequence numbers 212, representing only the image sections 116A, for local access by the GPU 108. One or more of the DPU and the host may retain information about a relationship between a sequence number and a header based in part on a relationship function 220. In one example, the relationship function 220 may be used to establish the sequence numbers. For example, the relationship function 220 may be a modulo function that extracts a number from a header and that applies a mathematical operation or function, such as the modulo function, to change the number from the header to provide a sequence number. Alternatively, the relationship function 220 may be a correlation table that maintains a tally of sequence numbers from a mathematical operation to relate to a header. Alternatively, the relationship function 220 is a transformation function that transforms information from the header to a sequence number.

Therefore, associations between the header and the sequence numbers that may be used to correlate the sequence numbers used with the header, in at least one embodiment. As used herein, local access between a processing unit and memory may be provided by such a processing unit and memory being within the same host machine or card. Further, as used herein, local access between a processing unit and memory by be provided by a PCIe bus instead of any network (such as, Ethernet) requirement. With respect to the provision by the DPU 122, the separate payload 206 with the sequence numbers 212 may be provided to a memory 202 associated with the GPU 108. The GPU 108 can access and process the separate payload P 15 to P 2N, representing only the image sections 116A of the images 116 in FIG. 1, using the sequence numbers S 1 to S N, for instance. Further, the system 200 may be such that at least one media stream 126 may include two media streams 126, 126A. In one example, the two media streams 126, 126A may be concurrently obtained by the image sensor and concurrently provided from the FPGA 106 to the DPU 122.

With respect to the two media streams 126, 126A, respective headers H 11 to H 1N and H 21 to H 2N that may be associated therewith may be separated from their respective payload P 11 to P 1N and P 21 to P 2N. The respective headers H 11 to H 2N may be provided for local access by a host machine 120 having a CPU 118. For example, the respective headers H 11 to H 2N may be in a local memory 104 associated with the CPU 118. In addition, the headers H 11 to H 1N for one of the media streams 126 may be provided in a manner that allows separate access by the host machine 120 to these headers, relative to the other headers H 21 to H 2N of the other one of the media streams 126A.

Still further, the system 200 may be such that a CPU 118 may be able to use information 214 that may be predetermined information provided for and from an application 134. For example, the predetermined information may be associated with different image sections 116A based in part on the image sections 116A representing different Rols. Further, the CPU 118 may be able to use information from the respective headers H 11 to H 1N and H 21 to H 2N in the local memory 104 as well. All such information may be used to inform 216 the DPU 122 of the separate payload 206 representing only the image sections 116A of the images 116 to be provided by the DPU 122 for access by the GPU 108. Further, instead of the CPU 118, the GPU 108 may inform 216 or indicate to the DPU 122 only the image sections to be received in the GPU 108 for the content layer processing. In at least one embodiment, the CPU 118 may cause predetermined information to be provided 222 to a GPU 108 to allow the GPU 108 to instruct or inform the DPU 122 as to the image sections 116A relevant to an application's requirement. However, in at least one embodiment, the GPU 108 need not receive information about image sections 308 and, instead, the GPU 108 may be limited by image processing capabilities and can inform the DPU 112 of the image sections 116A it needs to be able to perform its image processing intended for an application 134 and by the GPU 108.

When two media streams 126, 126A are concurrently provided from the FPGA, the payload P 15 to P 1N associated with an image section of a first one 126 of the two media streams may receive sequence numbers and may be provided for access by the GPU 108, along with additional payload P 21 to P 2N associated a second image section of a second one 126A of the two media streams. Further, the additional payload P 21 to P 2N may represent only additional image sections of the second one 126A of the two media streams, but are available with the payload P 15 to P 1N of the first one 126 of the two media streams for contiguous access by the GPU. As used herein, contiguous memory may be in reference to consecutive blocks of memory 202 that may be used for the payload P 15 to P 1N and P 21 to P 2N from the different media streams and that may represent the only respective image sections 116A of those different media streams. Contiguous access, as used herein, may be so that access to different sequential payload, even if from different media streams, may be obtained by a mapping of different buffers storing different parts of the payload for contiguous access.

In at least one embodiment, it is possible to obtain different payload from different media streams, but to store the different payload as sequential for contiguous access or in a contiguous buffer. For example, an application may be aware that a part of a view may be covered in one camera and another part of the view may be covered by another camera. Therefore, the application may indicate, using the information about the image sections 308, the payloads from different media streams are related. The indication may cause the GPU to obtain different payload from the DPU and may cause the GPU to retain the different payload, in a contiguous access or in a contiguous buffer, so that they can be stitched together for use in the application 134. Therefore, an application 134 may be such that it has an awareness of a layout sensors associated with the multi-sensor array 102. The sensors may be different cameras. The application 134 may be such that it has an awareness of the field of view of each sensor of the multi-sensor array 102 and is aware of a need to capture a view from the different sensors to be able to stitch together image sections for the application 134.

Therefore, in one example, the DPU 122 can store headers for a first payload of a first one of the concurrent media stream and additional headers for additional payload of a second one of the concurrent media streams in different ones of multiple buffers that may be in a host machine. These buffers are represented by the memory 138 of the host machine are distinct from a shared buffer, represented by a different memory 130, of a GPU 108. For example, the shared buffer is one of: local to the GPU, on a GPU card which comprises the GPU, or on an accelerator card or a converged card which comprises the GPU and the DPU, whereas the multiple may be local to a CPU 118 of the host machine or the DPU or are in the host machine or the DPU. The DPU can arrange the payload and the additional payload, belonging to the image sections and to additional image sections of the images, in contiguous ones of the designated locations of the shared buffer. Then, the GPU 108 is enabled to use the arrangement of the payload and the additional payload to stitch the image sections and the additional image sections together for use by at least one application 134 or for further processing by the GPU.

The system 200 may include a CPU 118 of a host machine 120 which may be adapted to use information 214 from the headers H 11 to H 2N to cause the GPU 108 to process the payload representing only the image sections of the images. However, the CPU 118 may usc predetermined information from an application 134 to inform a DPU 216 of the image sections to be provided to a GPU 108 to be processed as the payload. For example, the information 214 may cause the DPU 122 to provide only the payload P 15 to P 1N and P 21 to P 2N pertaining to the image sections 116A.

There may be no sequence numbers 218 provided for the remaining payload. The system 200 may also allow the headers H 11 to H 2N to be received for local access using a CPU 118 of a host machine 120. The CPU 118 may enable the DPU 122 to provide the payload P 15 to P 1N and P 21 to P 2N representing only the image sections 116A for local access by the GPU. Further, the CPU 118 may enable the GPU 108 to process the payload P 15 to P 1N and P 21 to P 2N representing only the image sections based in part on the sequence numbers 208 by making only these payload available from the DPU 122. Therefore, there need not be intervention from the CPU 118 to the GPU 108 in this regard. In addition, the system 200 is such that the DPU 122 can control the provision 210 of the separate payload 206 occurs over a stream bit rate and burst size which are associated with predictable workloads at a known consumption rate for the GPU 108.

FIG. 3 is an illustration of further aspects of a system 300 for arranging payload representing only image sections in a shared buffer to allow processing of only the image sections, in at least one embodiment. Like with respect to FIG. 2, the aspects of the system 300 in FIG. 3 may be all of or in part of the aspects already described with respect to one or more of systems 100 or 200 in FIG. 1 or 2. For example, the system 300 may include an image sensor which may be or may include a multi-sensor array 102, and which may be associated with the FPGA 106. The image sensor may be also associated with a GPU 108 and a DPU 122.

The FPGA 106 may be able to provide images 116 of at least one media stream 126 to the DPU 122, in the format of a payload. The DPU 122 may be able to receive information 308 about only image sections 116A of the images 116. The DPU 122 may be able to arrange payload 310 representing the image sections 116A in a shared and contiguous buffer 302 of the memory 202. The arrangement may be for the GPU 108 to access and may be based in part on designated locations 304 in the shared and contiguous buffer 302. In one example, a designated location may be to ensure contiguous storage or contiguous access. The GPU 108 can access the shared and contiguous buffer 302 and can process only the image sections 116A of the images.

Further, the system 300 may be such that the FPGA 106 can also provide concurrent media streams 126, 126A, to the DPU 122, as described with respect to FIG. 2. The DPU 122 can also store headers H 15 to H 2N for payload P 15 to P 1N and the first one of the concurrent media streams and can store additional headers H 21 to H 2N for additional payload P 21 to P 2N of the different one of the concurrent media streams. However, the different headers of the different media streams may be stored in different buffers B1 and B2 of the local memory 104 of the host 120. The DPU 122 can arrange the payload P 15 to P 2N of all the image sections 116A in contiguous ones of the designated locations 304 of the shared and contiguous buffer 302. Further, it is possible to store payload in a manner that allows for contiguous access instead of a contiguous buffer 302.

In at least one embodiment, the system 300 may be such that the shared and contiguous buffer 302 may be local to the GPU 108, such as, being with a graphics card 110 or other card. The different buffers B1, B2, to B N for the headers H 11 to H 2N, in a host 120, may be local to the host and accessible by a CPU 118 of the host 120. The system 120 may be such that the shared and contiguous buffer 302 is on a GPU or graphics card 110, as illustrated, where the GPU or graphics card 110 includes the GPU 108. However, in at least one example, the shared and contiguous buffer 302 may be on an accelerator or converged card that may include the GPU 108 and the DPU 122.

Further, the system 300 may be such that an image sensor includes a multi-sensor array 102, with different sensors therein to provide different and concurrent media streams 126, 126A of the at least one media stream. The system 300 may be such that the image sensor can also communicate concurrent media streams 126, 126A to the FPGA 106. In addition, the concurrent media streams 126, 126A may be associated with different User Datagram Protocol (UDP) ports of the FPGA and may use the different UDP ports to identify the different media streams 126, 126A to the DPU. The system may be such that the DPU 122 can discard 306 other payload that are other than the image sections 116A, following the arrangement 310 of the payload representing only the image sections 116A for the GPU 108.

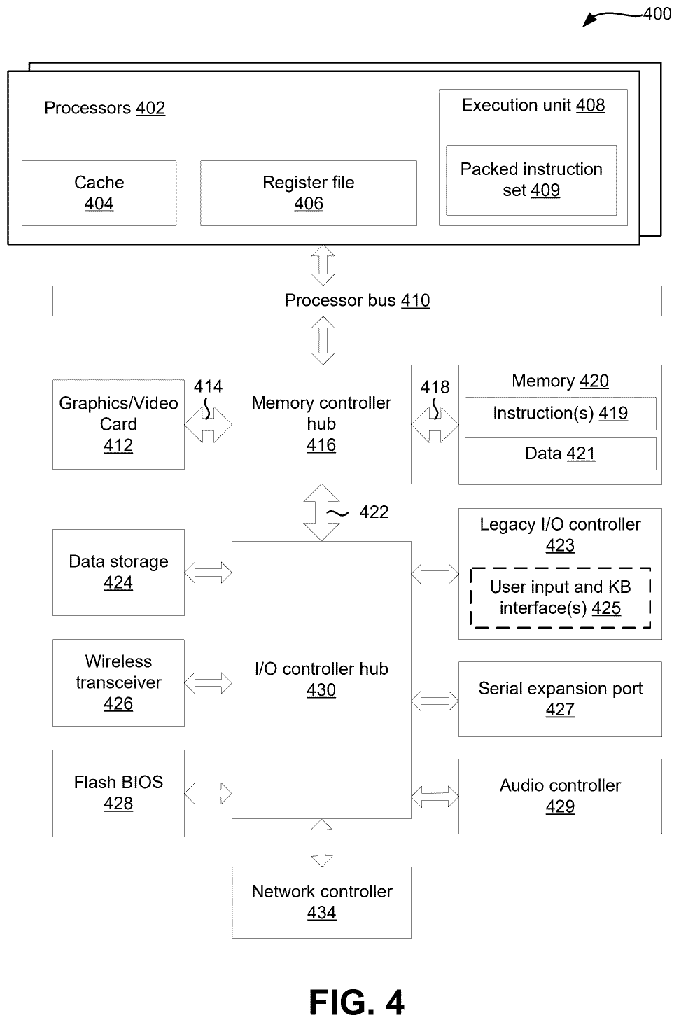

FIG. 4 illustrates computer and processor aspects 400 of a system for separating image sections from images in support of performing content layer processing of only image sections, in at least one embodiment. For example, each of the illustrated processors 402 may include one or more processing or execution units 408 that can perform any or all of the aspects of the systems 100-300 for separating image sections from images and to allow content layer processing of only the image sections. Therefore, the processors 402 may be at least a CPU but may include aspects of a GPU and a DPU. In addition, the systems 100-300 may include different interfaces between each of the FPGA, the GPU, and the DPU to allow communications as described all throughout herein.

The processing or execution units 408 may include multiple circuits to support the aspects described herein for separating image sections from images in support of performing content layer processing of only image sections. In at least one embodiment, the processors 402 may include CPUs, GPUs, DPUs that may be associated with a multi-tenant environment to perform one or more aspects of separating image sections from images in support of performing content layer processing of only image sections. Further, the GPUs may be distinctly in distinct graphics/video cards 412, relative to a DPU (represented by a network controller 434) and a CPU represented by the processors 402 illustrated in FIG. 4. Therefore, even though described in the singular, the graphics/video card 412 may include multiple cards and may include multiple GPUs on each card. This may be also the case with multiple DPUs on a network controller 434. In addition, it is also possible for a card to include DPUs and GPUs thereon to perform aspects herein for separating image sections from images in support of performing content layer processing of only image sections.

The computer and processor aspects 400 may be performed by one or more processors 402 that include a system-on-a-chip (SOC) or some combination thereof formed with a processor that may include execution units to execute an instruction, according to at least one embodiment. In at least one embodiment, the computer and processor aspects 400 may include, without limitation, a component, such as a processor 402 to employ execution units 408 including logic to perform algorithms for process data, in accordance with present disclosure, such as in embodiment described herein. In at least one embodiment, the computer and processor aspects 400 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, the computer and processor aspects 400 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, the computer and processor aspects 400 may include, without limitation, a processor 402 that may include, without limitation, one or more execution units 408 to perform aspects according to techniques described with respect to at least one or more of FIGS. 1-3 and 5-7 herein. In at least one embodiment, the computer and processor aspects 400 is a single processor desktop or server system, but in another embodiment, the computer and processor aspects 400 may be a multiprocessor system.

In at least one embodiment, the processor 402 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, a processor 402 may be coupled to a processor bus 410 that may transmit data signals between processors 402 and other components in computer and processor aspects 400.

In at least one embodiment, a processor 402 may include, without limitation, a Level 1 (“L1”) internal cache memory (“cache”) 404. In at least one embodiment, a processor 402 may have a single internal cache or multiple levels of internal cache. In at least one embodiment, cache memory may reside external to a processor 402. Other embodiments may also include a combination of both internal and external caches depending on particular implementation and needs. In at least one embodiment, a register file 406 may store different types of data in various registers including, without limitation, integer registers, floating point registers, status registers, and an instruction pointer register.

In at least one embodiment, an execution unit 408, including, without limitation, logic to perform integer and floating point operations, also resides in a processor 402. In at least one embodiment, a processor 402 may also include a microcode (“ucode”) read only memory (“ROM”) that stores microcode for certain macro instructions. In at least one embodiment, an execution unit 408 may include logic to handle a packed instruction set 409.

In at least one embodiment, by including a packed instruction set 409 in an instruction set of a general-purpose processor, along with associated circuitry to execute instructions, operations used by many multimedia applications may be performed using packed data in a processor 402. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, an execution unit 408 may also be used in microcontrollers, embedded processors, graphics devices, DSPs, and other types of logic circuits. In at least one embodiment, the computer and processor aspects 400 may include, without limitation, a memory 420. In at least one embodiment, a memory 420 may be a Dynamic Random Access Memory (“DRAM”) device, a Static Random Access Memory (“SRAM”) device, a flash memory device, or another memory device. In at least one embodiment, a memory 420 may store instruction(s) 419 and/or data 421 represented by data signals that may be executed by a processor 402.

In at least one embodiment, a system logic chip may be coupled to a processor bus 410 and a memory 420. In at least one embodiment, a system logic chip may include, without limitation, a memory controller hub (“MCH”) 416, and processors 402 may communicate with MCH 416 via processor bus 410. In at least one embodiment, an MCH 416 may provide a high bandwidth memory path 418 to a memory 420 for instruction and data storage and for storage of graphics commands, data, and textures. In at least one embodiment, an MCH 416 may direct data signals between a processor 402, a memory 420, and other components in the computer and processor aspects 400 and to bridge data signals between a processor bus 410, a memory 420, and a system I/O interface 422. In at least one embodiment, a system logic chip may provide a graphics port for coupling to a graphics controller. In at least one embodiment, an MCH 416 may be coupled to a memory 420 through a high bandwidth memory path 418 and a graphics/video card 412 may be coupled to an MCH 416 through an Accelerated Graphics Port (“AGP”) interconnect 414. In at least one embodiment, the graphics/video card 412 may be coupled to one or more of the processors 402 via a PCIe interconnect standard. Similarly, a network controller 424 may also be coupled to one or more of the processors 402 via a PCIe interconnect standard.

In at least one embodiment, the computer and processor aspects 400 may use a system I/O interface 422 as a proprietary hub interface bus to couple an MCH 416 to an I/O controller hub (“ICH”) 430. In at least one embodiment, an ICH 430 may provide direct connections to some I/O devices via a local I/O bus. In at least one embodiment, a local I/O bus may include, without limitation, a high-speed I/O bus for connecting peripherals to a memory 420, a chipset, and processors 402. Examples may include, without limitation, an audio controller 429, a firmware hub (“flash BIOS”) 428, a wireless transceiver 426, a data storage 424, a legacy I/O controller 423 containing user input and keyboard interface(s) 425, a serial expansion port 427, such as a Universal Serial Bus (“USB”) port, and a network controller 434. In at least one embodiment, data storage 424 may comprise a hard disk drive, a floppy disk drive, a CD-ROM device, a flash memory device, or other mass storage device.

In at least one embodiment, FIG. 4 illustrates computer and processor aspects 400, which includes interconnected hardware devices or “chips”, whereas in other embodiments, FIG. 4 may illustrate an exemplary SoC. In at least one embodiment, devices illustrated in FIG. 4 may be interconnected with proprietary interconnects, standardized interconnects (e.g., PCIe) or some combination thereof. In at least one embodiment, one or more components of the computer and processor aspects 400 that are interconnected using compute express link (CXL) interconnects.

Therefore, the at least one execution unit 408 may be a circuit of at least one processor 402 to be associated with a system for separating image sections from images in support of performing content layer processing of only image sections. The association may be such that the at least one execution unit 408 of at least one processor 402 can perform at least aspects of a GPU, aspects of a DPU, or aspects of a CPU. The association may be such that the at least one execution unit 408 of at least one processor 402 can load and run or execute instructions to perform such aspects. However, the association may be such that the at least one execution unit 408 of at least one processor 402 may be hardwired to perform such aspects.

Further, at least one execution unit 408 may be a circuit of at least one processor 402 that may be a CPU, a DPU, or a GPU, as in FIGS. 1-3, to perform aspects of separating image sections from images in support of performing content layer processing of only image sections. As such, the computer and processor aspects 400 may include multiple circuits that may include or be part of a GPU and that may include or be part of the FPGA, which is associated with the GPU. The FPGA may be to receive images from an image sensor. The FPGA may also perform physical layer processing for the images and can provide a media stream which includes the images, post-physical layer processing. The FPGA provides the media stream to a data processing unit (DPU). Separately, the GPU can perform content layer processing for only image sections of the images based in part on the image sections provided by the DPU from the media stream.

Further, the physical layer processing by the FPGA may include one or more of an analog-to-digital conversion (ADC), a noise estimation, or a timestamping. Separately, the content layer processing by the GPU may include one or more of pattern recognition, object recognition, feature extraction, feature characterization, or image segmentation. Further, the physical layer processing may be an operation which is oblivious to content of the images or which is performed only considering raw pixel data associated with the images. The physical layer processing may be an operation which is devoid of business or and which is independent or agnostic of an application requirement.

In one example, the content layer processing may include one or more operations which are to consider a content of the images or which are performed on raw pixel data with duc consideration to content within the images. The multiple circuits herein may be such that the DPU can interface with a GPU kernel. The GPU kernel allows the GPU to indicate the DPU only the image sections to be received for content layer processing. As a result, the GPU can receive only the image sections which are subject to the content layer processing in the GPU. The GPU can perform its image processing using command scripts of the GPU kernel. The multiple circuits herein may be such that the GPU can also communicate with the DPU, using a PCIe bus to indicate only the image sections to be received. This is so that the GPU can receive only the image sections from the DPU. The GPU is to perform the content layer processing in the absence of CPU intervention. The multiple circuits herein may be such that the GPU can also perform local access for the image sections provided by the DPU at least because the image sections are stored in a buffer that is local to the GPU.

Further, the at least one execution unit 408 may be a circuit of at least one processor 402 to be associated with a CPU, a DPU, or a GPU, as in FIGS. 1-3 to perform aspects of separating image sections from images in support of performing content layer processing of only image sections. As such, the computer and processor aspects 400 may include multiple circuits that may include or be part of a DPU and that may include or be part of a GPU. For example, the multiple circuits provide a DPU that is associated with a GPU. The DPU can receive images of at least one media stream from a FPGA that may be a distinct further circuit. The DPU can separate headers from payload associated with the images and can provide sequence numbers for the payload representing only image sections of the images. The DPU can provide the payload representing only the image sections for access that is associated with the GPU. This enables the GPU to access and process payload representing only the image sections using the sequence numbers.

The multiple circuits may be such that it can handle two or more media streams concurrently. For example, where there are two media streams from a FPGA, the DPU can provide the headers associated with a first one of the two media streams and can provide access by a host machine for the headers. The host may include a CPU as further part of the multiple circuits in one example. Further, the DPU can provide additional headers associated with a second one of the two media streams. Then, the additional headers can be provided for separate access in the host machine, relative to the headers associated with the first one of the two media streams. This may be at least because the different headers of the different media streams may be provided in different buffers, representing the different access.

The multiple circuits may be such that they enable the DPU to receive information as to the image sections from the CPU, based in part on predetermined information from an application that may be provided to the DPU. The CPU may also provide information as to the image sections using the headers and the additional headers. Then, the DPU can perform operations on the payload and the additional payload representing only the image sections of the images to be provided by the DPU for access by the GPU. The multiple circuits may be such that the payload associated with multiple media streams, representing multiple image sections of the multiple media streams, can be provided for contiguous access by the GPU. The multiple circuits may be such that the GPU can process the payload representing only the image sections of the images based in part on input from the CPU part of the multiple circuits that may be in a host machine and that uses information from as application the requires the image processing of the image sections.

The multiple circuits may be such that the headers of the media streams may be received for local access using a CPU part of the multiple circuits, in a host machine. The CPU can enable the DPU to provide the payload representing only the image sections for local access by the GPU. The CPU can enable the GPU to process the payload representing only the image sections based in part on the sequence numbers. The multiple circuits may be such that the DPU can control provision of the payload over a stream bit rate and burst size which are associated with predictable workloads at a known consumption rate for the GPU.

Further, the at least one execution unit 408 may be a circuit of at least one processor 402 to be associated with a CPU, a DPU, or a GPU, as in FIGS. 1-3 to perform aspects of separating image sections from images in support of performing content layer processing of only image sections. As such, the computer and processor aspects 400 may include multiple circuits that may include or be part of a GPU and that may include or be part of a DPU. For example, the multiple circuits may include the GPU and the DPU, where the DPU can receive images of at least one media stream from a FPGA that may be another of the multiple circuits. The FPGA may be associated with an image sensor. The DPU can receive information about image sections of the images and can arrange payload representing the image sections in a shared buffer for the GPU. The arrangement may be based in part on designated locations in the shared buffer. In one example, the designated locations may be contiguous blocks within the shared buffer assigned to media streams or sequence numbers associated with the payload. The GPU can access the shared buffer to process only the image sections of the images.

The multiple circuits may be such that the DPU can also receive concurrent media streams of the at least one media stream. The DPU can store headers for the payload, along with additional headers for additional payload of a different one of the concurrent media streams, in different ones of multiple buffers associated with a host. In one example, the DPU may use a relationship function to retain header information and sequence numbers that may be based on a transformation of the header information. Differently, the arrangement of the payload and the additional payload proceeds using the contiguous ones of the designated locations of the shared buffer.

Further, the shared buffer may be local to the GPU by being on a same card as the GPU, while the multiple buffers are local to a CPU by being within a same host machine hosting the CPU. Alternatively, the buffer may be on a GPU card which also includes the GPU. Still further, the shared buffer may be on an accelerator or converged card which may also include the GPU and the DPU. The multiple circuits may also be such that the DPU can discard other payload that are other than the at least one image section following the arrangement of the payload representing only the at least one image section for the GPU.

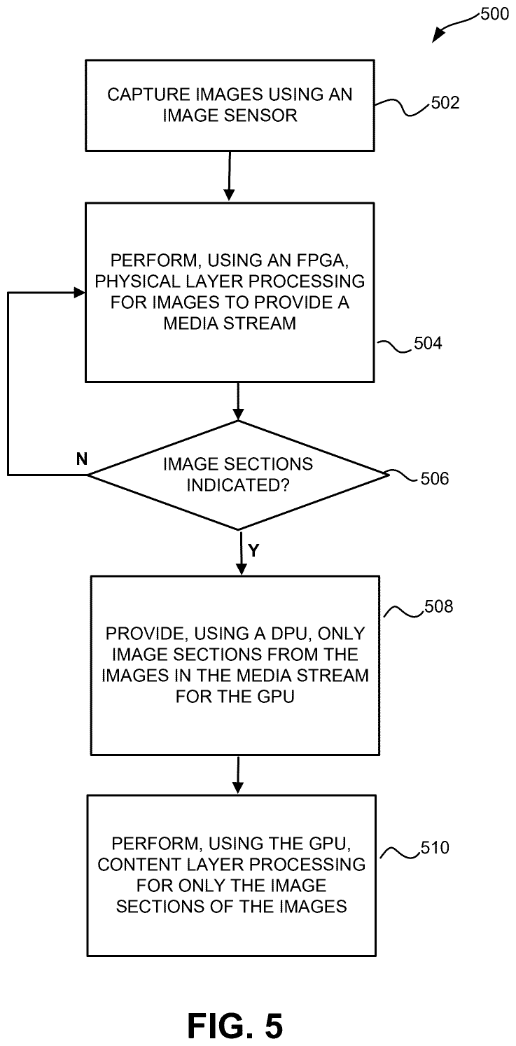

FIG. 5 illustrates a process flow or method 500 for a system for separating physical layer processing for images from content layer processing for only image sections of the images, in at least one embodiment. The method 500 may include capturing 502 images using an image sensor. The method 500 may include performing 504, using a FPGA, physical layer processing for images to provide a media stream. The method 500 may include verifying or determining 506 that image sections are indicated. In one example, this may be based in part on information from a CPU of a host machine. The method 500 may include providing 508, using a DPU, only image sections from the images in the media stream for the GPU. The method 500 may also include performing 510, using the GPU, content layer processing for only the image sections of the images.

The method 500 may include a further step or sub-step for enabling the GPU to communicate with the DPU using a PCIe bus. The method 500 may include a further step or sub-step for receiving only the image sections in the GPU using the PCIe bus. Further, the content layer processing in the GPU may be performed, absent intervention from a CPU. The method 500 may include a further step or sub-step for providing the image sections by the DPU for local access by the GPU. The method 500 may include a further step or sub-step for determining designated locations in the local access for payload representing only the image sections. Then, locally accessing may be performed, using the GPU, for the payload representing only the image sections. The GPU may perform the content layer processing for the payload representing only the image sections following the local access.

In the method 500, the physical layer processing may be an operation which is oblivious to content of the images or which is performed only considering raw pixel data associated with the images. Alternatively, the physical layer processing may be an operation which is devoid of business logic or which is independent or agnostic of an application requirement. The content layer processing may include one or more operations which are to consider a content of the images or which are performed on raw pixel data with due consideration to content within the images.

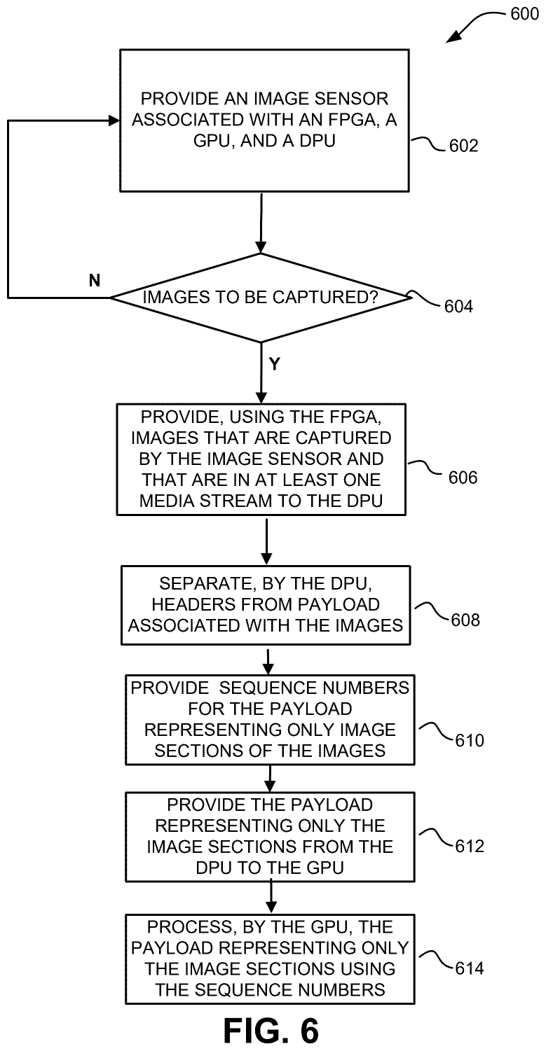

FIG. 6 illustrates yet another process flow or method 600 for a system for providing sequence numbers for payload representing only image sections of images, in at least one embodiment. The method 600 of FIG. 6 may be used with the method 500 of FIG. 5. In one example, the method 600 may include providing 602 an image sensor associated with a FPGA, a GPU, and a DPU. The method 600 may include verifying or determining 604 that images are to be captured using the image sensor. The method 600 may include providing 606, using the FPGA, images that are captured by the image sensor and that are in at least one media stream to the DPU. The method 600 may include separating 608, by the DPU, headers from payload associated with the images.

The method 600 may include providing 610 sequence numbers for the payload representing only image sections of the images. Further, the method 600 may include providing 612 the payload representing only the image sections, by the DPU, for access by the GPU. This may be based in part on information from a CPU that has access to the headers from the payload. The method 600 may include processing 614, by the GPU, the payload representing only the image sections using the sequence numbers.

The method 600 may be such that the at least one media stream includes two media streams. The headers may be associated with a first one of the two media streams and may be provided for access by a host machine having a CPU. Further, additional headers may be associated with a second one of the two media streams. The additional headers may be provided for separate access, relative to the headers associated with the first one of the two media streams, by the host machine. The method 600 may include a further step or sub-step for informing the DPU of the payload representing only the image sections of the images to be provided by the DPU for access by the GPU. The informing may be based in part on the CPU providing input using information from an application associated with a DPU. The CPU may use information also from the headers and the additional headers.

The method 600 may be such that at least one media stream includes two media streams and where the payload may be associated with a first one of the two media streams. The payload may represent only the image sections of the first one of the two media streams. The payload may be provided for access by the GPU, along with additional payload that may be associated with a second one of the two media streams. For example, the additional payload may represent only additional image sections of the second one of the two media streams and may be provided for contiguous access by the GPU, along with the payload associated with the first one of the two media streams.

The method 600 may include a further step or sub-step for processing, using the GPU, the payload representing only the image sections of the images. This may be based in part on input from a CPU of a host machine. The CPU may use information from an application to provide the input. The application may be one that requires the image processing for the image or for the image sections to be performed, in one example. The CPU may use information from the headers to provide the input, in another example. The method 600 may include a further step or sub-step for controlling, by the DPU, the provision of the payload over a stream bit rate and burst size which are associated with predictable workloads at a known consumption rate for the GPU.

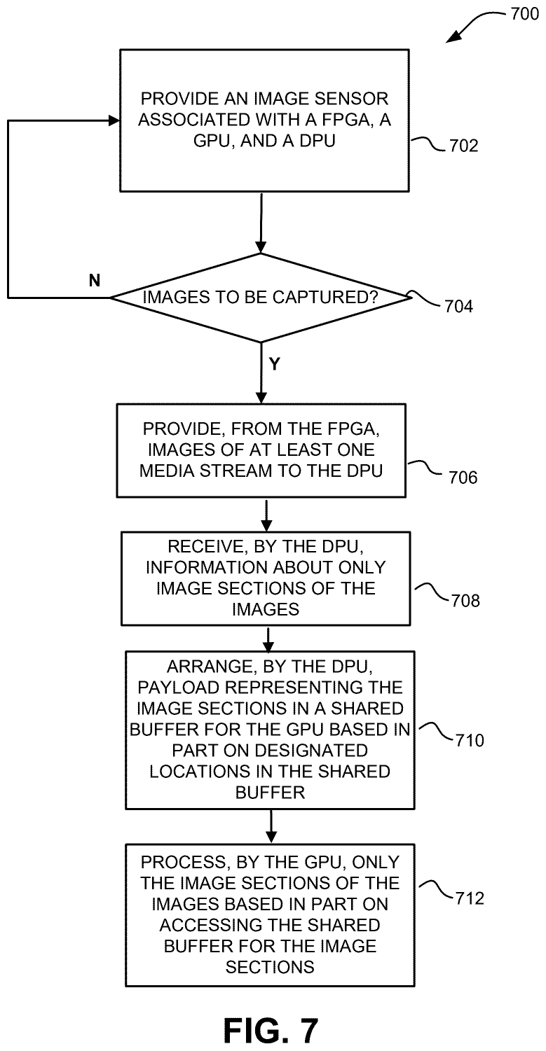

FIG. 7 illustrates a further process flow or method 700 for a system for arranging payload representing only image sections in a shared buffer, in at least one embodiment. The method 700 of FIG. 7 may be used with the method 500 of FIG. 5 or the method 600 of FIG. 6. The method 700 may include providing 702 an image sensor associated with a FPGA, a GPU, and a DPU. The method 700 may include verifying or determining 704 if images are to be captured by the image sensor. The method 700 may include providing 706, from the FPGA, images of at least one media stream to the DPU. The method 700 may include receiving 708, by the DPU, information about only image sections of the images. This may be from a CPU based in part on access and indications from an application instead of or together with the headers associated with the payload that represents the image sections. The method 700 may include arranging 710, by the DPU, the payload representing the image sections in a shared buffer for the GPU based in part on designated locations in the shared buffer. The method 700 includes processing 712, by the GPU, only the image sections of the images based in part on accessing the shared buffer for the image sections.

The method 700 may include a further step or a sub-step for providing, by the FPGA, concurrent media streams of the at least one media stream to the DPU. The method 700 may include a further step or a sub-step for storing, by the DPU, headers for the payload and additional headers for additional payload of a different one of the concurrent media streams in different ones of multiple buffers. Instead of the headers, a transformation function performed to aspects of the header may provide information that may be retained with the DPU. The method 700 may include a further step or a sub-step for arranging, by the DPU as part of step 710, the payload and the additional payload in contiguous ones of the designated locations of the shared buffer.

The method 700 may be such that the shared buffer is local to the GPU. The multiple buffers may be local to a CPU of a host machine. The method 700 may be such that the shared buffer is on a GPU card which may include the GPU or is on a NIC which may include the GPU and the DPU. The different buffers may be in the host machine. The method 700 may be such that the image sensor may include a multi-array sensor. The method 700 may include a further step or a sub-step for providing, by different sensors of the multi-array sensor, different and concurrent media streams of the at least one media stream to the FPGA. The concurrent media streams may be associated with different UDP ports of the FPGA. The method 700 may include a further step or a sub-step for discarding, by the DPU, other payload that are other than the image sections following the arrangement of the payload representing only the image sections for the GPU.

In the following description, numerous specific details are set forth to provide a more thorough understanding of at least one embodiment. However, it will be apparent to one skilled in the art that the inventive concepts may be practiced without one or more of these specific details.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors.

In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. References may also be made to providing, outputting, transmitting, sending, or presenting analog or digital data. In at least one embodiment, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system comprising a data processing unit (DPU) to receive image data associated with captured images of at least one media stream, the image data comprising payload and headers, the DPU further to separate the headers from the payload, to provide sequence numbers for the payload to represent only image sections of the images, and to provide only the image sections in a shared buffer for access by a graphics processing unit (GPU) to enable the GPU to process the payload representing only the image sections using the sequence numbers.

2. The system of claim 1, further comprising:
an image sensor to capture the images; and
a field programmable gate array (FPGA) to receive the images and to provide the image data as concurrent media streams of the at least one media stream.

3. The system of claim 2, wherein the DPU is further to store the headers for the payload of a first one of the concurrent media stream and additional headers for additional payload of a second one of the concurrent media streams in different ones of a plurality of buffers that are distinct from the shared buffer, wherein the DPU is further to arrange the payload and the additional payload, belonging to the image sections and to additional image sections of the images, in contiguous ones of the designated locations of the shared buffer, and wherein the arrangement of the payload and the additional payload enables the GPU to stitch the image sections and the additional image sections together for use by at least one application or for further processing by the GPU.

4. The system of claim 3, wherein the shared buffer is local to the GPU and wherein the plurality of buffers are local to a central processing unit (CPU) of a host machine or the DPU.

5. The system of claim 3, wherein the shared buffer is on a GPU card which comprises the GPU and wherein the plurality of buffers are in the host machine or the DPU.

6. The system of claim 3, wherein the shared buffer is on an accelerator card or a converged card which comprises the GPU and the DPU and wherein the plurality of buffers are in the host machine or the DPU.

7. The system of claim 3, wherein the DPU is further to discard other payload that are other than the image sections following the arrangement of the payload representing only the image sections for the GPU.

8. The system of claim 2, wherein the image sensor comprises a multi-array sensor, and wherein different sensors of the multi-array sensor provide different and concurrent media streams of the at least one media stream.

9. The system of claim 2, wherein the image sensor is further to communicate concurrent media streams of the at least one media stream to the FPGA, and wherein the concurrent media streams are associated with different User Datagram Protocol (UDP) ports of the FPGA.

10. The system of claim 1, wherein the at least one media stream includes two media streams, wherein the headers are associated with a first one of the two media streams and are provided in a first buffer for access by a host machine comprising a central processing unit (CPU), wherein additional headers are associated with a second one of the two media streams, and wherein the additional headers are provided for in a second buffer for separate access, relative to the headers associated with the first one of the two media streams, by the host machine.

11. The system of claim 8, wherein the CPU or the GPU is to use information from an application to inform the DPU of the payload representing only the image sections of the images to be provided by the DPU to the GPU.

12. The system of claim 1, wherein the at least one media stream includes two media streams, wherein the payload are associated with a first one of the two media streams, representing only the image sections of the first one of the two media streams, and are provided in the shared buffer for access by the GPU, and wherein additional payload are associated with a second one of the two media streams, representing only additional image sections of the second one of the two media streams, and are provided in the shared buffer or a different buffer for contiguous access, with the payload associated with the first one of the two media streams, by the GPU.

13. The system of claim 1, further comprising a central processing unit (CPU) of a host machine, the CPU to use information from an application to cause the GPU to process the payload representing only the image sections of the images.

14. The system of claim 1, wherein the headers are received for local access using a central processing unit (CPU) of a host machine, wherein the CPU enables the DPU to provide the payload representing only the image sections for local access by the GPU, and wherein the CPU enables the GPU to process the payload representing only the image sections based in part on the sequence numbers.

15. The system of claim 1, wherein the DPU is to control the provision of the payload over a stream bit rate and burst size which are associated with predictable workloads at a known consumption rate for the GPU.

16. A plurality of circuits comprising at least a data processing unit (DPU) to receive image data associated with captured images of at least one media stream, the image data comprising payload and headers, the DPU further to separate the headers from the payload, to provide sequence numbers for the payload to represent only image sections of the images, and to provide only the image sections in a shared buffer for access by a graphics processing unit (GPU) to enable the GPU to process the payload representing only the image sections using the sequence numbers.

17. The plurality of circuits of claim 16, further comprising:
an image sensor to capture the images, the image sensor comprising a multi-array sensor, wherein different sensors of the multi-array sensor provide different and concurrent media streams of the at least one media stream; and
a field programmable gate array (FPGA) to receive the images and to provide the image data as the different and concurrent media streams of the at least one media stream.

18. The plurality of circuits of claim 16, wherein the shared buffer is one of: local to the GPU, on a GPU card which comprises the GPU, or on an accelerator card or a converged card which comprises the GPU and the DPU.

19. The plurality of circuits of claim 16, wherein the headers are to be stored in a first one of a plurality of buffers, wherein the plurality of buffers are distinct from the shared buffers and are local to a central processing unit (CPU) of a host machine or the DPU or are in the host machine or the DPU, wherein the headers are for the payload of a first one of concurrent media streams of the at least one media stream, and wherein additional headers for additional payload of a second one of the concurrent media streams are in second one of a plurality of buffers.

20. A method for image processing comprising:
receiving, in a data processing unit (DPU) image data associated with captured images of at least one media stream, the image data comprising payload and headers,
separating, by the DPU, the headers from the payload;
providing sequence numbers for the payload to represent only image sections of the images; and
providing only the image sections in a shared buffer for access by a graphics processing unit (GPU) to enable the GPU to process the payload representing only the image sections using the sequence numbers.

21. The method of claim 20, further comprising:
capturing the images using an image sensor, the image sensor comprising a multi-array sensor, and wherein different sensors of the multi-array sensor provide different and concurrent media streams of the at least one media stream;
receiving the images in a field programmable gate array (FPGA); and
providing, from the FPGA, the image data as the different and concurrent media streams of the at least one media stream.

22. The method of claim 20, wherein the shared buffer is one of: local to the GPU, on a GPU card which comprises the GPU, or on an accelerator card or a converged card which comprises the GPU and the DPU.

23. The method of claim 20, further comprising:
storing, by the DPU, the headers for the payload of a first one of the concurrent media stream and additional headers for additional payload of a second one of the concurrent media streams in different ones of a plurality of buffers that are distinct from the shared buffer;
arranging, by the DPU the payload and the additional payload, belonging to the image sections and to additional image sections of the images, in contiguous ones of the designated locations of the shared buffer; and
enabling, using the arrangement of the payload and the additional payload, the GPU to stitch the image sections and the additional image sections together for use by at least one application or for further processing by the GPU.
